(19) United States
(12) Patent Application Publication
(10) Pub. No.: US 2017/0158032 A1
(43) Pub. Date: Jun. 8, 2017

(54) DOOR CURTAIN APPARATUS FOR AUTOMOBILE

(71) Applicant: Hyundai Motor Company, Seoul (KR)

(72) Inventor: Young Uk Yun, Suwon (KR)

(21) Appl. No.: 15/192,788

(22) Filed: Jun. 24, 2016

(30) Foreign Application Priority Data
Dec. 7, 2015 (KR) 10-2015-0173186

(51) Int. Cl. B60J 1/20

(52) U.S. Cl. CPC B60J 1/2086

(57) ABSTRACT

A door curtain device for a vehicle is provided. The door curtain device includes a roll portion around which a curtain is wound and a housing having a first portion with the curtain roll portion disposed therein and a second portion configured to extend from the first portion and expands or retracts the curtain therefrom. Further, a weather strip is directly coupled to the second portion of the housing.

### CROSS-REFERENCE TO RELATED APPLICATION

This application claims priority to and the benefit of Korean Patent Application No. 10-2015-0173186 filed in the Korean Intellectual Property Office on Dec. 7, 2015, the entire contents of which are incorporated herein by reference.

### BACKGROUND

(a) Field of the Invention

The present invention relates to a door curtain device for a vehicle and more particularly to a door curtain with minimal interference with the passenger compartment of the vehicle.

(b) Description of the Related Art

Generally, a door curtain device for a vehicle is a curtain device disposed within a door of the vehicle. A conventional vehicle door curtain device includes a curtain roll portion where a curtain is wound and a housing that surrounds the curtain roll portion.

Typically, a conventional vehicle door curtain device is disposed between an interior trim and an interior panel of the door. However, since the door curtain device is disposed between the interior trim and the interior panel of the door, an additional cavity where the door curtain device is located is required between the interior trim and the interior panel, thereby reducing an internal passenger compartment for occupants of the vehicle.

The above information disclosed in this section is merely for enhancement of understanding of the background of the invention and therefore it may contain information that does not form the prior art that is already known in this country to a person of ordinary skill in the art.

### SUMMARY

The present invention provides a door curtain device for a vehicle that may minimize interference with respect to an internal passenger compartment of the vehicle.

In one aspect, a door curtain device for a vehicle, may include a roll portion around which a curtain is wound, a housing having a first portion where the curtain roll portion is disposed and a second portion that extends from the first portion and where the curtain expands or retracts and a weather strip directly coupled to the second portion of the housing.

The weather strip may contact the door glass of the vehicle. The door curtain device may further include a hook portion separated from the weather strip, interposing the second portion of the housing therebetween and directly coupled to the housing. The hook portion may be coupled with an end portion of a door interior panel of the vehicle. The housing may be disposed between the door interior panel and the door glass. The weather strip may be integrally formed with the housing.

According to an exemplary embodiment of the present invention, a door curtain device for a vehicle may minimize interference an internal passenger compartment of the vehicle.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary cross-sectional view of a door curtain device for a vehicle according to an exemplary embodiment of the present invention;

FIG. 2 is an exemplary cross-sectional view of the door curtain device of FIG. 1, provided between a door interior panel and door glass of the vehicle according to an exemplary embodiment of the present invention; and

FIG. 3 is an exemplary cross-sectional view provided for description of the effect of the door curtain device according to the exemplary embodiment of the present invention compared to a conventional door curtain device.

### DETAILED DESCRIPTION

The present invention will be described more fully hereinafter with reference to the accompanying drawings, in which exemplary embodiments of the invention are shown. While the invention will be described in conjunction with exemplary embodiments, it will be understood that present description is not intended to limit the invention to those exemplary embodiments. On the contrary, the invention is intended to cover not only the exemplary embodiments, but also various alternatives, modifications, equivalents and other exemplary embodiments, which may be included within the spirit and scope of the invention as defined by the appended claims. The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items. For example, in order to make the description of the present invention clear, unrelated parts are not shown and, the thicknesses of layers and regions are exaggerated for clarity. Further, when it is stated that a layer is “on” another layer or substrate, the layer may be directly on another layer or substrate or a third layer may be disposed there between. A part without concerning to the description is omitted so as to clearly describe the present invention.

It is understood that the term “vehicle” or “vehicular” or other similar term as used herein is inclusive of motor vehicle in general such as passenger automobiles including sports utility vehicles (SUV), buses, trucks, various commercial vehicles, watercraft including a variety of boats, ships, aircraft, and the like and includes hybrid vehicles, electric vehicles, combustion, plug-in hybrid electric vehicles, hydrogen-powered vehicles and other alternative fuel vehicles (e.g. fuels derived from resources other than petroleum).

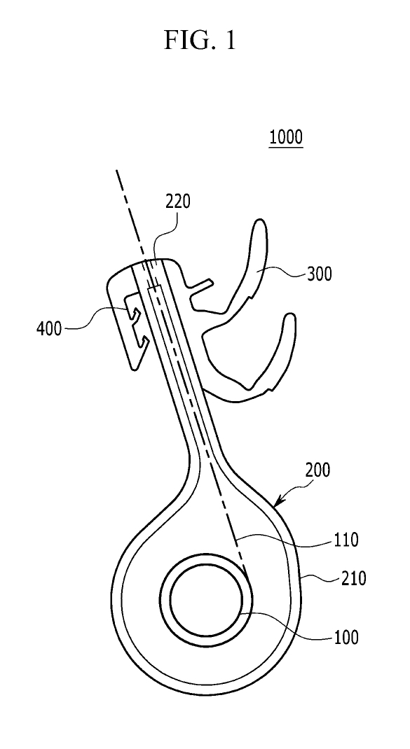

Hereinafter referring to FIG. 1, a door curtain device for a vehicle according to an exemplary embodiment of the present invention will be described. FIG. 1 is an exemplary cross-sectional view of a door curtain device for a vehicle according to an exemplary embodiment of the present invention. As shown in FIG. 1, a door curtain device 1000 for a vehicle according to an exemplary embodiment having a curtain device disposed in a door of a vehicle may include a curtain roll portion 100, a housing 200, a weather strip 300, and a hook portion 400.

The curtain roll portion 100 may be supported in the housing 200. The curtain roll portion 100 may include a wound curtain 110, and specifically the curtain roll portion 100 may include a curtain 110 wound around a rotation shaft. Rotation of the rotation shaft of the curtain roll portion 100 causes the curtain 110 to expand from or be retracted into the housing 200. The curtain roll portion 100 may be connected with a driver motor configured to rotate the curtain roll portion 100, and the curtain 110 of the curtain roll portion 110 may be expanded from or retraced into the housing 200 by the driver. The housing 200 may surround the curtain roll portion 100. The curtain roll portion 100 may be supported within the housing 200.

The housing 200 may include a first portion 210 and a second portion 220. The first portion 210 of the housing 200 may form a support cavity within in the housing 200, and the curtain roll portion 100 may be disposed within in the support space. In other words, the curtain roll portion 100 may be disposed in the first portion 210 of the housing 200. The second portion 220 of the housing 200 may extend in one direction from the first portion 210, and may form an entrance cavity connected with the support space. The second portion 220 of the housing 200 may form an end portion of the second portion 220. The curtain 110 of the curtain roll portion 110 may to be expanded from or retracted into the housing 200 through the entrance cavity formed by the second portion 220 of the housing 200. For example, the curtain 110 may be expanded from or retracted into the housing 200 through the second portion 220 of the housing 200. The housing 200 may be disposed between the door interior panel and the door glass of the vehicle. The weather strip 300 may be directly connected to an exterior side of the second portion 220 of the housing 200. The weather strip 300 may be directly connected to the second portion 220 of the housing 200 and may contact the second portion 220 of the housing 200. The weather strip 300 may contact the door glass of the vehicle to guide the door glass. The weather strip 300 may include a flexible material (e.g., rubber or the like). Furthermore, in the exemplary embodiment of the present invention, the weather strip 300 may be directly coupled to the housing 200, but in another exemplary embodiment of the present invention, the weather strip 300 may be integrally formed with the housing 200 and thus being directly coupled thereto. In particular, the housing 200 and the weather strip 300 may be formed through a single injection process. The hook portion 400 may be separated from the weather strip 300, interposing the second portion 220 of the housing 200 therebetween and thus directly connected to an exterior side of the second portion 220 of the housing 200. The hook portion 400 may contact the second portion 220 of the housing 200 and may be directly coupled to the second portion 220 of the housing 200. The hook portion 400 may be supported by the door interior panel and may support the housing 200 when coupled with an end portion of the door interior panel.

Moreover, in the exemplary embodiment of the present invention, the hook portion 400 may be directly coupled to the housing 200. Alternatively in another exemplary embodiment of the present invention, the hook portion 400 may be integrally formed with the housing 200 and may be directly coupled to the housing 200. In particular, the housing 200 and the hook portion 400 may be formed through a single injection process.

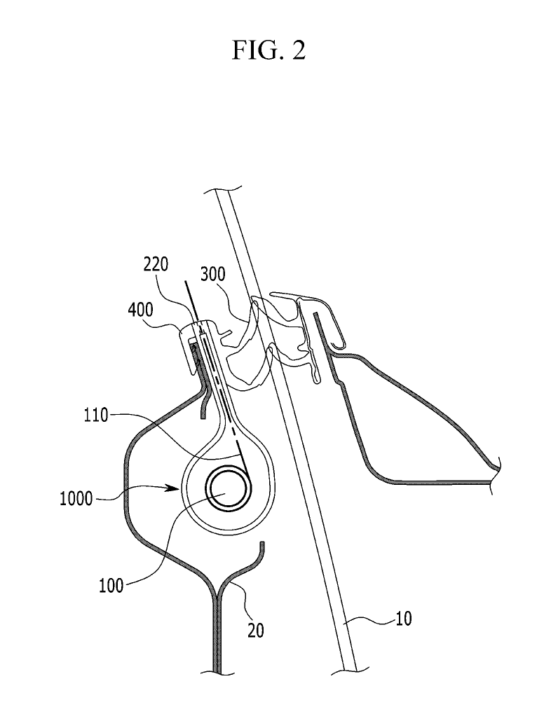

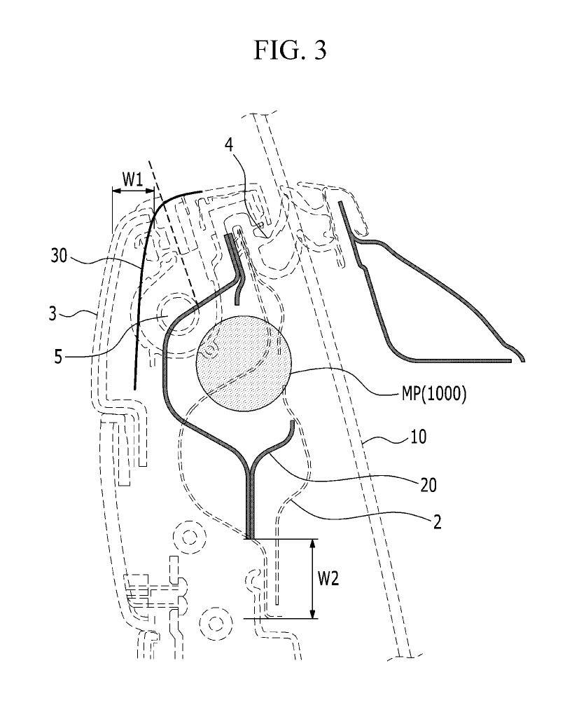

The door curtain device 1000 according to an exemplary embodiment of the present invention may be disposed in a door of a vehicle, and this will be described with reference to FIG. 2. FIG. 2 is an exemplary cross-sectional view of the door curtain device shown in FIG. 1, and is provided between the door interior panel and the door glass of the vehicle. As shown in FIG. 2, the door curtain device 1000 may be disposed within the door of the vehicle, and may be disposed between a door interior panel 20 and a door glass 10. Specifically, the hook portion 400 of the door curtain device 1000 may be coupled to an end of the door interior panel 20, and thus, the hook portion 400 may be supported by the door interior panel 20 and the housing 200 to which the hook portion 400 is directly connected may be disposed between the door interior panel 20 and the door glass 10 while being supported by the door interior panel 20. In particular, the weather strip 300 may be directly coupled to the housing 200 and may be separated from the hook portion 400 that contacts the door glass 10 and the door glass 10 may be configured to guide a vertical movement. The door curtain device 1000 disposed in the door of the vehicle may have the following effect, and this will be described with reference to FIG. 3. FIG. 3 is an exemplary cross-sectional view provided for description of the effect of the door curtain device according to the exemplary embodiment of the present invention, compared to a conventional door curtain device. As shown in FIG. 3, a conventional door curtain device 5 is disposed between a door interior trim 3 and a door interior panel 2 to which a weather strip 4 is coupled. Thus, the conventional door curtain device 5 requires an additional cavity between the door interior trim 3 and the door interior panel 2.

However, the door curtain device 1000 according to the exemplary embodiment of the present invention may include a cavity MP between the door interior panel 20 and the door glass 10 and may have a connection with the weather strip. Accordingly, an additional cavity may be omitted between the door interior panel 20 and the door interior trim 30.

Accordingly, compared to the conventional door curtain device, a passenger compartment may be expanded as much as a first length W1 in a horizontal direction, and as much as a second length W2 in a vertical direction within in the door. The additional cavity spaced within the door may reduce the number of assembly processes and the number of components, may reduce the weight of the vehicle, and may improve design of the vehicle through the margin space. In other words, although the door curtain device 1000 may be disposed in the door, interference with respect to the internal passenger compartment of the vehicle may be minimized, thereby reducing the number of assembly processes and the number of components, reducing the weight of the vehicle, and improving design of the vehicle through the additional space in the passenger compartment of the vehicle.

While this invention has been described in connection with what is presently considered to be exemplary embodiments, it is to be understood that the invention is not limited to the disclosed exemplary embodiments, but, on the contrary, is intended to cover various modifications and equivalent arrangements included within the spirit and scope of the appended claims.

### DESCRIPTION OF SYMBOLS

curtain 110
curtain roll portion 100
first portion 210
second portion 220
housing 200
weather strip 300

What is claimed is:

1. A door curtain device for a vehicle, comprising:
a roll portion around which a curtain is wound;
a housing that includes a first portion with the curtain roll portion disposed thereon and a second portion configured to extend from the first portion and where the curtain expands or retracts; and
a weather strip directly coupled to the second portion of the housing.

2. The door curtain device of claim 1, wherein the weather strip is coupled to door glass of the vehicle.

3. The door curtain device of claim 2, further comprising:
a hook portion spaced apart from the weather strip, interposing the second portion of the housing therebetween and directly coupled to the housing.

4. The door curtain device of claim 3, wherein the hook portion is coupled with an end portion of a door interior panel of the vehicle.

5. The door curtain device of claim 4, wherein the housing is disposed between the door interior panel and the door glass.

6. The door curtain device of claim 1, wherein the weather strip is integrally formed with the housing.
